(19) United States
(12) Patent Application Publication
(10) Pub. No.: US 2008/0198836 A1
(43) Pub. Date: Aug. 21, 2008

(54) Method and Apparatus For Synchronization in Wireless Communication System

(75) Inventor: Yanmeng Sun, Shanghai (CN)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 11/993,202

(22) PCT Filed: Jun. 24, 2005
(86) PCT No.: PCT/IB06/51997

§ 371 Date: Dec. 19, 2007

(30) Foreign Application Priority Data
Jun. 24, 2005 (CN) 200510082005.4

(51) Int. Cl. H04J 3/06

(52) U.S. Cl. 370/350

(57) ABSTRACT

For a transmission signal for a wireless communication system and a method and apparatus for performing synchronization processing for the transmission signal provided by the present invention, the principal ideas is that, a synchronization sequence is respectively inserted into a group of transmission datum according to predetermined time offsets to form a group of transmission signals. The synchronization sequences inserted into the transmission datum are obtained respectively by performing a phase modulation for the same known basic synchronization sequence according to the predetermined phase offsets, dispersed in the same transmission signal period without overlapping with each other, and transmitted by different transmit antennas. By using the transmission signals and the structure of their synchronization sequences, the receiver side only needs to search a part of the received signals, then one of an expected group of synchronization sequences, served as the main synchronization sequence, can be acquired quickly, and based on this, the synchronization positions of the transmission signals from other transmit antennas can be estimated, at the same time, by using the phase offsets between the synchronization sequences and the basic synchronization sequence, the transmission signals from different transmit antennas can be distinguished effectively.

### FIELD OF THE INVENTION

The present invention relates to a wireless communication system, and more particularly relates to method and apparatus for synchronization in a wireless communication system.

### BACKGROUND OF THE INVENTION

Generally, wireless signals are blocked by the obstacles in propagation paths, which causes reflection, scattering and attenuation. Thus, the signals received by the antenna in the receiver side actually are a linear superposition of the multi-path signals arriving from different paths. Moreover, the multi-path signals from the different paths have different time delay, amplitude, phase and frequency, namely different channel fading parameters.

On the other hand, with the development of the mobile communication technology, people have higher requirements for the data transmission speed and the quality of received signals of the mobile communication system. However, in the conventional communication system, the available resources such as the frequency band, time slot and frequency spreading code are very limited. Consequently, to further improve the data transmission speed, one solution is to utilize the space resource more effectively. Nowadays, the Multiple Input Multiple Output (MIMO) technology that receives more extensive recognition from the academy and the industry, employs multiple transmit antennas and receive antennas to form multiple parallel wireless communication channels in space. Consequently, by utilizing the space resource adequately, the frequency spectrum efficiency and the data transmission speed of the system are improved. For example, the Bell Lab Layered Space Time (BLAST) technology that is presented by the Bell Lab is described in detail with reference to the document, G. D. Golden, G. J. Foschini, R. A. Valenzuela and P. W. Wolniansky, “Detection algorithm and initial laboratory results using V-BLAST space-time communication architecture,” Electronics Letters, vol. 35, January 1999.

A MIMO communication system employs multiple transmit antennas (N_{T}) and multiple receive antennas (N_{R}), and its system configuration is shown in FIG. 1. On the transmitter side, the data generated by the data source (30) is divided into N_{T}-path data by the DEMUX (32), and after encoded and interleaved by the encoding and interleaving units (34-0, 34-1, . . . , 34-N_{T}-1), the N_{T}-path data are processed by the Tx space-time processing unit (36) to form N_{T}-path encoded signals. Subsequently, after modulated by the transmitters (TMTR) (38-0, 38-1, . . . 38-N_{T}-1), the N_{T}-path encoded signals are transmitted via the antennas (10-0, 10-1, . . . , 10-N_{T}-1).

On the receiver side, the multi-path signals received from the receive antennas (20-0, 20-1, . . . , 20-N_{R}-1) are performed RF (Radio Frequency) processing by the receivers (RCVR) (40-0, 40-1, . . . , 40-N_{R}-1) to form baseband signals. Then, the baseband signals are synchronized by the synchronization processing units (41-0, 41-1, . . . , 41-N_{R}-1) to acquire the synchronization positions of the transmission signals from different antennas. Next, the baseband signals are performed a space-time processing by the Rx space-time processing unit (42), and after decoded and de-interleaved by the decoding and de-interleaving units (44-0, 44-1, . . . , 44-N_{R}-1), the multi-path data are acquired. Subsequently, the acquired multi-path data are combined by the MUX (46) to restore the user data and the user data are buffered in the data sink (48).

A MIMO channel formed by N_{T} transmit antennas and N_{R} receive antennas can be decomposed to N_{S} independent sub-channels, wherein N=N_{T}·N_{R}. With reference to the document, Lucent, Nokia, Siemens, Ericsson. “A standardized set of MIMO radio propagation channels”. TSGR1#23(01) 1179, 19-23 Nov. 2001, Jeju, Korea, in physics, each of the above independent sub-channels means a spatial sub-channel of the MIMO channel and corresponds to a one-dimension vector in the MIMO channel matrix. The MIMO technology can provide improved performance for the frequency spectrum efficiency and data transmission speed of the system if other spatial sub-channels formed by the multiple transmit and receive antennas (corresponding to the other one-dimension vectors in the MIMO channel matrix) are utilized adequately.

Certainly, there are some assumptions to implement the MIMO technology and achieve its excellent performance. For example, before the receiver side starts the spatial-temporal joint detection for the transmission data, the synchronization procedure of all sub-channels must be achieved. As a result, there is a higher requirement for the synchronization of the system. On the other hand, the channel parameters of the wireless channel may vary because of the difference of the transmission path and time, which will cause the channel parameters of the forgoing N_{S} independent sub-channels in the same MIMO system, including the multiple-path time delay, to be different with each other. To implement the synchronization for the signal of the forgoing spatial sub-channels, generally, a certain synchronization sequence will be inserted into the transmission data frame at a specific segment, the number of the synchronization sequences equals to the number of the transmit antennas (N_{T}). To distinguish each transmit antenna in the receiver side, these synchronization sequences are selected with good cross-correlation performance.

FIG. 2 shows the structure of the transmission frame that comprises synchronization sequences in a conventional MIMO system. Wherein, S₀, . . . S_{N-1} are the synchronization sequences, T_{f} is the period of the transmission frame. The different transmission frames (2-0, 2-1, . . . , 2-N_{T}-1) are coupled to the N_{T} transmit antennas respectively and will be transmitted by them.

FIG. 3 shows a functional block diagram of the synchronization processing units in the conventional MIMO system. In the MIMO receiver side, each receive antenna receives signals from all N_{T} transmit antennas. For each receive antenna, the receiver needs N_{T} parallel sliding correlators (52(i, 0), 52(0, 1), . . . 52(0, N_{T}-1), i=0, 1, . . . , N_{T}-1 corresponding to the different transmit antennas respectively), and performs the correlation processing for each of the received transmission signals according to the equation (1):

$${y}_{m}^{n} [ j ] = {\vert {\sum }_{i = 0}^{L - 1} {S}_{m}^{*} [ i ] \times {r}_{n} [ i \times {R}_{os} + j ] \vert}^{2} \\ m = 0 , 1 , … , {N}_{T} - 1 ; n = 0 , 1 , … , {N}_{R} - 1 \qquad ( 1 )$$

Wherein, rₙ[i] is the signals received by the nth receive antenna, Sₘ[i] is the synchronization sequence corresponding to the mth transmit antenna, [·]* represents conjugation processing, i=0, . . . , L-1, L is the length of the synchronization sequence, Rₒₛ is the over-sampling rate, yₘⁿ[j] represents the output result of the corresponding sliding correlators, and j is the output sequence number. The output results of the correlation processing are calculated by the corresponding power calculators 54 (N_{T}·N_{R}), and then the calculated power values are respectively compared with the predetermined threshold values in the peak-value detectors (N_{T}·N_{R}). Consequently, the sliding positions that correspond to the correlation values with the maximum peak-value are the corresponding synchronization reference positions. During the above processing, to guarantee the initial acquisition of the synchronization sequences Sₘ[i], the duration of the parallel sliding correlation processing must be at least the repeating period of the synchronization sequences, and in the MIMO system shown in FIG. 3, the repeating period of the synchronization sequences is the transmission frame period T_{f}.

After the respective parallel sliding correlation processing for each of the groups of signals transmitted in the N_{S}=N_{T}·N_{R} spatial sub-channels formed by multiple transmit antennas and multiple receive antennas, the corresponding N_{S} correlation peak-values are acquired, the N_{S} correlation peak-values can be used as the synchronization time reference for the corresponding N_{S} spatial sub-channels in the receiver side.

It can be found from the above description of the synchronization method in the conventional MIMO system and the functional block diagram shown in FIG. 3 that, a large amount of the correlation operations are required to implement the synchronization in the MIMO system. Roughly speaking, for a MIMO system with N_{T} transmit antennas and N_{R} receive antennas, the computational amount required to accomplish the synchronization of the N_{S}=N_{T}·N_{R} spatial sub-channels is N_{S} times of the conventional Single In Single Out (SISO) system. For example, with reference to the IEEE Std.80211a-1999: “Wireless LAN Medium Access Control (MAC) and Physical Layer (PHY) specification, High-speed Physical Layer in the 5 GHz Band”, in the IEEE 802.11n WLAN system, a 4×4 MIMO system is adopted. Assuming the length of the synchronization sequence is 160 chips, the repeating period of the transmission frame is 4096 frames, and the over-sampling rate is 4, then the whole synchronization procedure requires at least 4×4×4096×4=262144 times of correlation processing with the length of 160. To be more exactly, about 41,943,040 multiply-accumulation (MAC) operations should be executed for the whole synchronization procedure.

Such mass computational amount requirement brings challenges to the implementation of the MIMO system synchronization and its real-time performance. On the other hand, the duration of the sliding correlation processing required to acquire the synchronization sequences will consequentially affect the speed of the system synchronization. Certainly, some parallel processing methods can be used to expedite the synchronization procedure, however, the corresponding price is the increment of system complexity and hardware cost.

In summary, a synchronization method that effectively adapts to the characteristics of the MIMO system needs to be provided, so that the computational amount of the correlation processing during the synchronization procedure can be reduced, and the synchronization procedure of the receiving signals from different transmit antennas can be simplified and accelerated.

### OBJECT AND SUMMARY OF THE INVENTION

One of the objects of the present invention is to provide a transmission signal for a wireless communication system and a method and apparatus for system synchronization by using a synchronization signal, to reduce the computational amount of the correlation processing during the synchronization procedure, and simplify and accelerate the synchronization procedure of the received signals from different transmit antennas.

A group of transmission signals for the wireless communication system according to the present invention, wherein the transmission signals each has a certain transmission time, and comprises a synchronization sequence and at least one data segment, wherein the synchronization sequences are respectively inserted into the transmission data at different positions according to predetermined time offsets, and do not overlap with each other on a time axis. The synchronization sequences inserted into the transmission data are obtained respectively by performing a phase modulation for the same known basic synchronization sequence according to the predetermined phase offsets, dispersed in the same transmission signal period without overlapping with each other, and transmitted by different transmit antennas.

A method for synchronization in a receiver of a wireless communication system according to the present invention, comprising the steps of: performing correlation processing for a group of transmission signals extracted from received signals by using a known basic synchronization sequence, to acquire one of an expected group of synchronization sequences as a main synchronization sequence, and an instant corresponding to a correlation peak-value of the main synchronization sequence is a synchronization reference point; determining, based on the synchronization reference point and a predetermined relation between the group of synchronization sequences and the known basic synchronization sequence, a sequence number of the main synchronization sequence and its synchronization position relative to the specific time segment of the transmission signal; and acquiring, based on the sequence number and the synchronization position of the main synchronization sequence and a predetermined relation between the main synchronization sequence and other synchronization sequences of the group of synchronization sequences, other synchronization sequences respectively.

An apparatus for synchronization in a receiver of a wireless communication system According to the present invention, comprising: a first acquiring means, for performing a correlation processing for a group of transmission signals extracted from received signals by using a known basic synchronization sequence, to acquire one of an expected group of the synchronization sequences as a main synchronization sequence, wherein an instant corresponding to a correlation peak-value of the main synchronization sequence is a synchronization reference point; a determining means, for determining, based on the synchronization reference point and a predetermined relation between the group of synchronization sequences and the known basic synchronization sequence, an sequence number of the main synchronization sequence and its synchronization position relative to a specific time segment in the transmission signal; and a second acquiring means, for acquiring, based on the sequence number and the synchronization position of the main synchronization sequence and a predetermined relation between the main synchronization sequence and other synchronization sequences of the group of synchronization sequences, other synchronization sequences respectively.

By using the transmission signals and the structure of their synchronization sequences provided by the present invention, the receiver side only needs to search a part of the receiving signals, then one of an expected group of synchronization sequences, served as the main synchronization sequence, can be acquired quickly, and based on this, the synchronization positions of the transmission signals from other transmit antennas can be estimated, at the same time, by using the phase offsets between the synchronization sequences and the basic synchronization sequence, the transmission signals from different transmit antennas can be distinguished effectively. Compared with the conventional method that comprises multiple synchronization sequences inserted into the same position of the transmission signals, the synchronization method provided by the present invention does not need to perform the synchronization acquiring respectively for all the transmission signals from different transmit antennas in the whole period of the signal, consequently, the relevant computational amount can be reduced and the synchronization procedure of the transmission signals from different transmit antennas can be accelerated.

### BRIEF DESCRIPTION OF THE DRAWINGS

FIG. 1 is a schematic diagram illustrating the configuration of the MIMO communication system.

FIG. 2 is a schematic diagram illustrating the structure of transmission signals that comprise synchronization sequences in a transmitter side of the MIMO communication system.

FIG. 3 is a functional block diagram of a synchronization processing unit of the MIMO communication system.

FIG. 4 is a schematic diagram illustrating the structure of the frame that comprises synchronization sequences for the MIMO communication system according to an embodiment of the present invention.

FIG. 5 is a schematic diagram illustrating the structure of the phase offset of the synchronization sequences for the MIMO communication system according to an embodiment of the present invention.

FIG. 6 is a method flowchart for generating the transmission signals for the MIMO communication system according to an embodiment of the present invention.

FIG. 7 is a functional block diagram of the transmission signal generating apparatus for the MIMO communication system according to an embodiment of the present invention.

FIG. 8 is a method flowchart for the synchronization for the MIMO communication system according to an embodiment of the present invention.

FIG. 9 is a schematic diagram illustrating the relative time offset of the synchronization sequences for the MIMO communication system according to an embodiment of the present invention.

FIG. 10 is a schematic diagram illustrating the synchronization apparatus for the MIMO communication system according to an embodiment of the present invention.

Throughout the drawings, the same reference numerals denote the similar or corresponding characteristics or functions.

### DETAILED DESCRIPTION FOR THE INVENTION

The structure of the synchronization signal for the wireless communication system, the method for generating the synchronization signals and the method and apparatus for performing the synchronization processing by utilizing the structure of the synchronization signals, which are provided by the present invention, will be described below in detail with reference to the drawings.

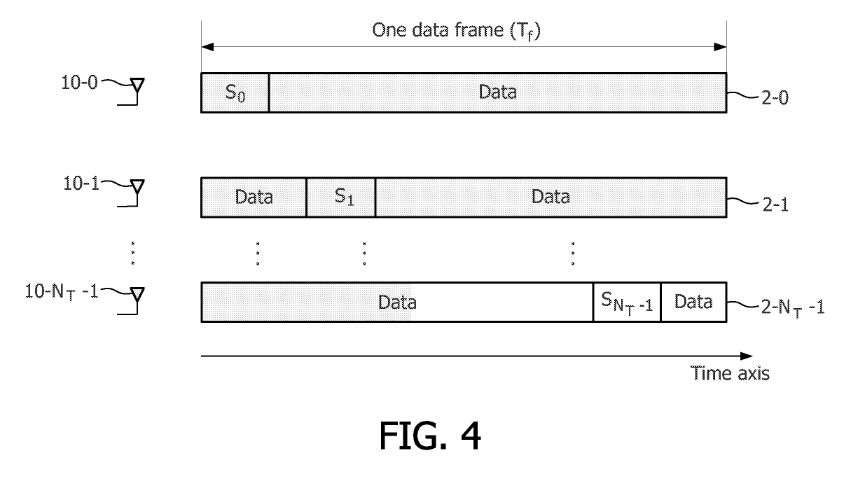

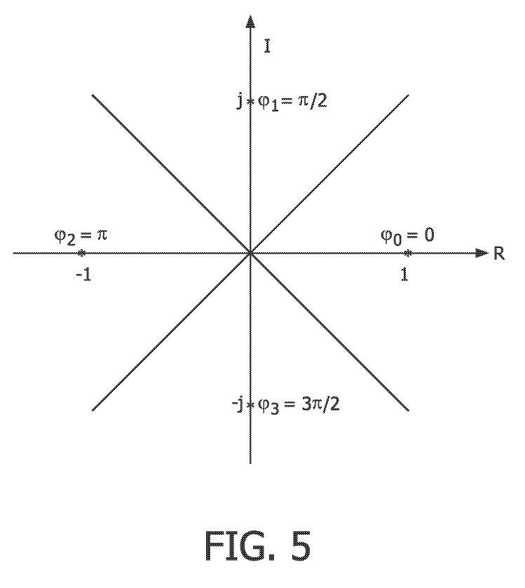

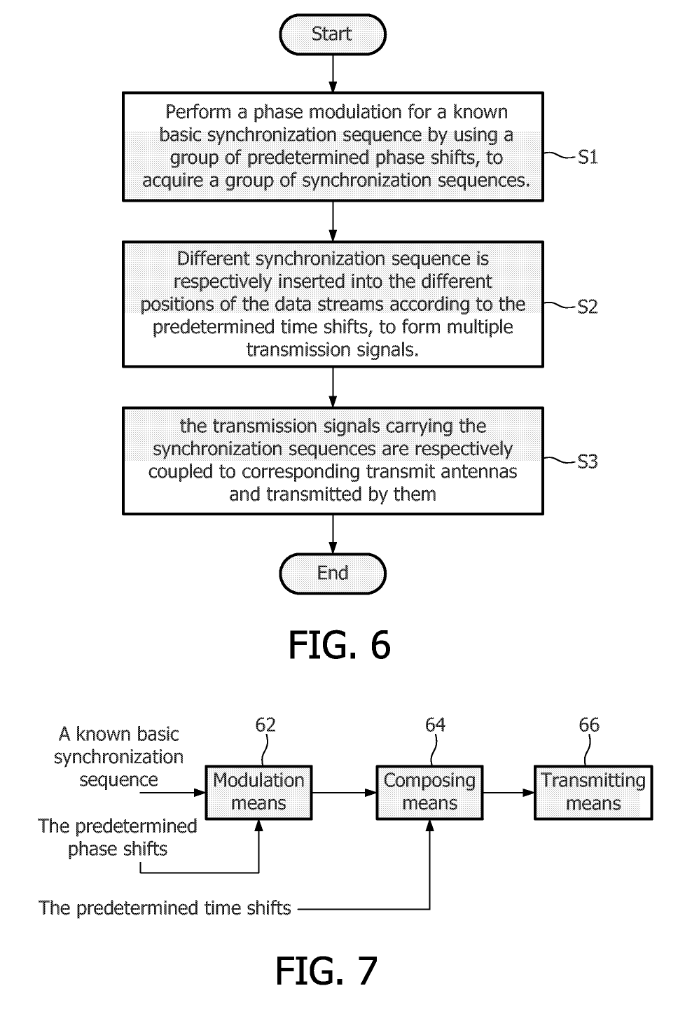

FIG. 4 shows a schematic diagram illustrating the structure of the transmission signals that comprise the synchronization sequences for the MIMO communication system according to an embodiment of the present invention. FIG. 5 shows a schematic diagram illustrating the structure of the phase offset of the synchronization sequences for the MIMO communication system according to an embodiment of the present invention. FIG. 6 and FIG. 7 respectively show a method flowchart for generating the transmission signals and a functional block diagram of the transmission signal generating apparatus.

As shown in FIG. 4, each transmission signal in a group of the transmission signals has a known duration, and comprises a synchronization sequence and at least one data segment, wherein, each synchronization sequence is respectively inserted into a different position in a corresponding transmission signal according to a predetermined time offset, and do not overlap with each other in the time axis.

Furthermore, each synchronization sequence inserted into the different position in the corresponding transmission signal is respectively obtained by performing a phase modulation processing for a known basic synchronization sequence according to a predetermined phase offset, and the phase offset of each synchronization sequence is different with each other, and its range is [0, 2π].

The above transmission signals will be further described below with reference to the mathematical expression.

First, a known basic synchronization sequence S is performed phase modulation by using a group of predetermined phase offsets to acquire a group of synchronization sequences {Sₘ|m=0, . . . , N_{T}-1}, wherein the number of synchronization sequences equals the number of the transmit antennas N_{T} (step S1). The phase offset relation between the synchronization sequences Sₘ and the basic synchronization sequence S can be expressed as:

Sₘ=S·e^{j(mφ+φ)} m=0,1, . . . ,N_{T}-1 (2)

Wherein, the basic sequence S is a certain sequence with good auto-correlation performance, such as the m sequence, the Gold sequence, etc.; mφ+φ is the predetermined phase offset; φ is the initial phase offset of the basic synchronization sequence S; and φ is defined as:

$$ϕ = \frac{2 π}{{N}_{T}} \qquad ( 3 )$$

Assuming N_{T}=4, then the number of the synchronization sequences is 4, the phase offset for each synchronization sequence relative to the basic synchronization sequence is shown in FIG. 5, and is

$$ϕ = 0 , \frac{π}{2} , π , \frac{3 π}{2}$$

respectively.

Next, the synchronization sequences {Sₘ|m=0, . . . , N_{T}-1} are respectively inserted into the different positions of the data streams according to the predetermined time offsets, to form N_{T} transmission signals (Step S2). As shown in FIG. 4, assuming that the repeating period of the transmission signals is the data frame period T_{f}, and the synchronization sequences are dispersed on the time axis evenly, then the corresponding time offsets of the inserted points relative to the frame head of the transmission frame can be expressed as:

$${t}_{m} = \frac{m}{{N}_{T}} \cdot {T}_{f} m = 0 , 1 , … , {N}_{T} - 1 \qquad ( 4 )$$

Wherein, the synchronization sequences are dispersed within the same transmission frame and are not overlap with each other on the time axis.

Finally, the transmission signals carrying the synchronization sequences are respectively coupled to transmit antennas and transmitted by them (Step S3). In the present embodiment, the number of synchronization sequences {Sₘ|m=0, . . . , N_{T}-1} from the structure of the synchronization sequences for the MIMO system equal the number of transmit antennas N_{T} in the MIMO system, moreover, each the synchronization sequences corresponds to one of the transmit antennas.

The above method for generating transmission signals in the mobile communication system described with reference to the FIG. 4-6 can be implemented in software, hardware, or the combination of software and hardware. When the above method for generating transmission signals is implemented in hardware or the combination of software and hardware, the corresponding apparatus is shown in FIG. 7. The apparatus for generating and transmitting the above transmission signals comprises: a modulation means 62, a composing means 64 and a transmitting means 66. Wherein, the modulation means 62 is used for performing the phase modulation for a known basic synchronization sequence by utilizing a group of predetermined phase offsets, to acquire a group of synchronization sequences (executing the functions as shown in equations (2) and (3)); The composing means 64 is used for inserting the synchronization sequences into the different positions of data streams according to predetermined time offsets, to form a group of transmission signals (executing the function as shown in equation (4)); The transmitting means 66 is used for coupling the formed transmission signals to the corresponding transmit antennas respectively and transmit them by the transmit antennas.

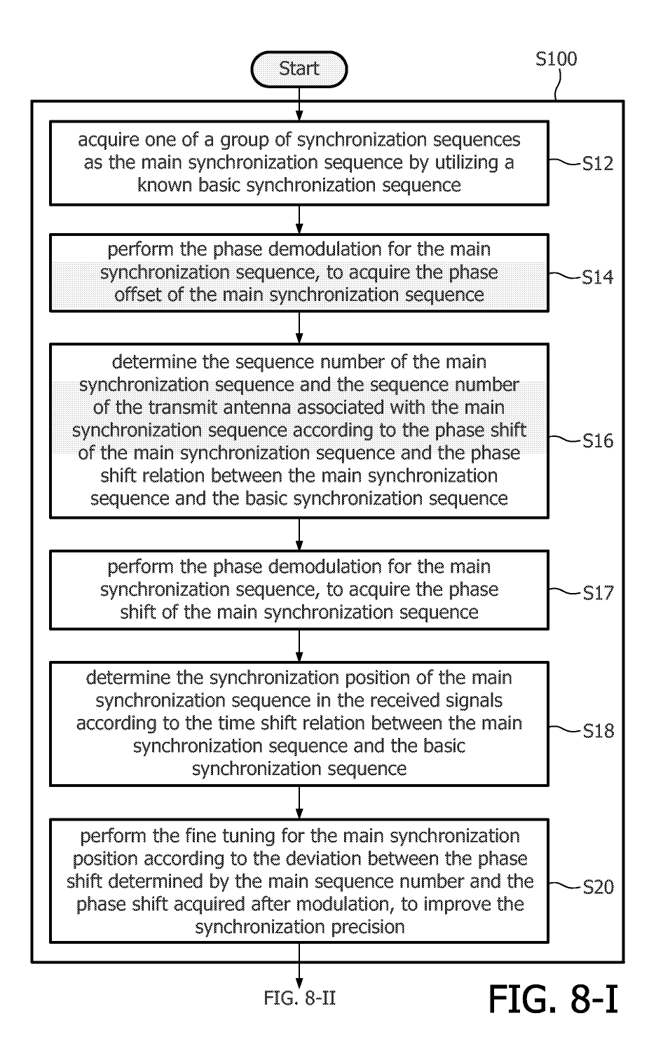

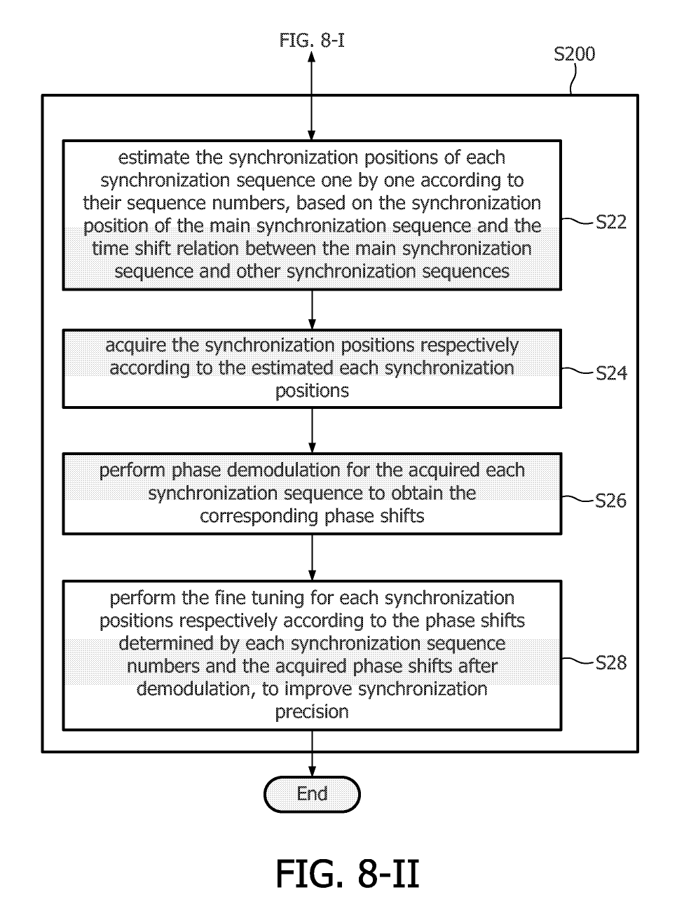

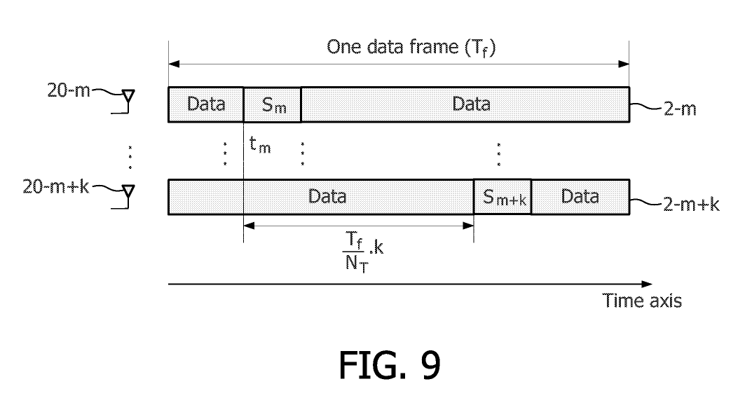

FIG. 8 shows a method flowchart for the synchronization of the MIMO communication system according to an embodiment of the present invention. FIG. 9 shows a schematic diagram illustrating the relative time offset of the synchronization sequences for the MIMO communication system according to an embodiment of the present invention. The synchronization method provided by the present invention will be described below with reference to FIG. 8 and FIG. 9.

By utilizing the above transmission signals and the structure of their synchronization sequences, the synchronization procedure in the receiver side can be divided into two stages: a system preliminary synchronization procedure (Step S100) and an antenna synchronization procedure (Step S200). At the system preliminary synchronization procedure, the receiver side only needs to search (sliding correlation) a part of the received transmission signals by utilizing the known basic synchronization sequence, then one of an expected group of the synchronization sequences, served as the main synchronization sequence, can be acquired quickly. At the antenna synchronization procedure, by utilizing the acquired main synchronization sequence in the system preliminary synchronization procedure as the synchronization position base, and by utilizing the predetermined time offset and phase offset relation between the synchronization sequences and the known basic synchronization sequence, the expected synchronization positions of the synchronization sequences in the transmission signals from other transmit antennas can be estimated, and the transmission signals from different transmit antennas can be distinguished effectively.

The synchronization procedure in the receiver side will be described below in detail with reference to FIG. 8 and the mathematical expression.

In the system preliminary synchronization procedure, the sliding correlation processing is first performed for the received signals by utilizing a known basic synchronization sequence S, to acquire one of a group of synchronization sequences as the main synchronization sequence (Step S12). Wherein, the time point corresponding to the correlation peak-value of the main synchronization sequence is the main synchronization time reference. Assuming the number of the receive antennas is N_{R}, the sliding correlation processing can be expressed as the mathematical expression:

$${y}^{n} [ j ] = {\vert {\sum }_{i = 0}^{L - 1} {S}^{*} [ i ] \times {r}_{n} [ i \times {R}_{os} + j ] \vert}^{2} n = 0 , 1 , … , {N}_{R} - 1 \qquad ( 5 )$$

Wherein, rₙ[i] are the signals received by the n th receive antenna, S[i] is the known basic synchronization sequence, [·]* represents the conjugation processing, i=0, . . . , L-1, L is the length of the synchronization sequence, Rₒₛ is the over-sampling rate, yⁿ[j] represents the output result of the corresponding sliding correlators, and j is the output sequence number. If only the objective synchronization sequence segment of the receiving signals is considered, the equation (5) can accordingly be expressed as:

$${y}^{n} [ j ] = {\vert {\sum }_{i = 0}^{L - 1} {S}^{*} [ i ] \times \{ {S}_{m} [ i \times {R}_{os} + j ] + {\sum }_{{k = 0}_{k \neq m}}^{{N}_{T} - 1} {d}_{k} ( j ) + δ ( j ) \} \vert}^{2} \\ n = 0 , 1 , … , {N}_{R} - 1 ; \\ m = 0 , 1 , … , {N}_{T} - 1 ; \qquad ( 6 )$$

Wherein, dₖ(j) is the data signals transmitted by other N_{T}-1 antennas, which overlaps with the nth receive antenna in the time axis; δ(j) is the noise generated by a transmission channel. Due to the good auto-correlation performance of the basic synchronization sequence, the data signals in the equation (6) has no correlation with the synchronization sequences, consequently, the output of the correlation of the corresponding data and noise with the basic synchronization sequence can be ignored, and then the equation (6) can be expressed as:

$${y}^{n} [ j ] = {\vert {\sum }_{i = 0}^{L - 1} {S}^{*} [ i ] \times {S}_{m} [ i \times {R}_{os} + j ] \vert}^{2} \\ n = 0 , 1 , … , {N}_{R} - 1 ; m = 0 , 1 , … , {N}_{T} - 1 \qquad ( 7 )$$

The equation (7) means that the receiver side can acquire any received synchronization sequence by utilizing the peak detection of the correlation processing. It can be found from the specific structure of the synchronization sequences shown in FIG. 4 that, a synchronization sequence Sₘ must appear within

$$\frac{1}{{N}_{T}} \cdot {T}_{f}$$

time period, namely, the corresponding sliding correlation processing of the synchronization sequences only lasts at most 1/N_{T} transmission frame period to acquire one of a group of the synchronization sequences as the main synchronization sequence. However, in the conventional synchronization method, to guarantee the acquisition of the synchronization sequences, the time duration of the parallel sliding correlation processing must be at least T_{f}. Therefore, the speed of the acquisition may be accelerated by utilizing the synchronization method provided by the present invention. It is noted that, except for the acquisition speed being accelerated, the method provided by the present invention only needs to utilize the basic synchronization sequence to perform the parallel sliding correlation processing for the multi-path signals received by N_{R} receive antennas, which is different with the method for the synchronization procedure of the conventional MIMO system that utilizes multiple synchronization sequences to perform the sliding correlation, therefore, the synchronization procedure provided by the present invention is much simpler than the conventional synchronization method.

The main synchronization sequence is further performed the phase demodulation, to acquire the corresponding phase offset (Step S14), the phase offset can be utilized to determine the sequence number of the main synchronization sequence and the sequence number of the transmit antenna associated with the main synchronization sequence (Step S16). By utilizing the acquired sequence number of the main synchronization sequence and the time offset relation between it and the known basic synchronization sequence, the time offset tₘ of the main synchronization sequence relative to the beginning point of the transmission frame in the received signals can be determined (Step S18).

The phase demodulation of the main synchronization sequence can be obtained according to the following equation:

$${ϕ}_{m}^{′} = arctg \frac{Im [ {\sum }_{i = 0}^{L - 1} {S}^{*} [ i ] \times {S}_{m} [ i \times {R}_{os} + j ] ]}{Re [ {\sum }_{i = 0}^{L - 1} {S}^{*} [ i ] \times {S}_{m} [ i \times {R}_{os} + j ] ]} - φ \qquad ( 8 )$$

Wherein, Re[·] and Im[·] respectively represent the in-phase component and the orthogonal component of the signal. The receiver side can determine the sequence number of the main synchronization sequence and the sequence number of the transmit antenna associated with the main synchronization sequence by the following equation:

$$m = ⌊ \frac{{ϕ}_{m}^{′}}{ϕ} + 0.5 ⌋ \qquad ( 9 )$$

Wherein, └·┘ represents rounding. If, FIG. 5 shows the corresponding relation between the phase offset, the sequence number of the synchronization sequences and the sequence number of the transmit antennas associated with the synchronization sequences when the number of transmit antennas N_{T}=4 and the initial phase offset of the basic synchronization sequence φ=0.

Because of the affection of the channel noise, the real modulation phase of the main synchronization sequence (Acquired at step S14) may have deviation with the expected modulation phase (Acquired according to the sequence number of the main synchronization sequence and its predetermined phase offset relative to the known basic synchronization sequence), consequently, by utilizing the deviation, the synchronization position of the correlation processing for the main synchronization sequence may be tuned finely to improve the synchronization precision (Step S20). Wherein, the procedure of the synchronization fine tuning is basically the same as the processing described by the equations (5)-(7), and the difference is that the basic position of the correlation peak-value is certain during the procedure of the fine tuning, therefore, the sliding range of the sliding correlator is correspondingly small, and the object is to pursuit the precision gradually, so that the correlation peak-value can approach its actual position much more closely.

Under the prerequisite that the system preliminary synchronization procedure is achieved, the antenna synchronization stage may be started, namely, other synchronization sequences in the transmission signals are synchronized.

First, based on the synchronization position of the main synchronization sequence and the predetermined time offset relation between the main synchronization sequence and other synchronization sequences, the synchronization positions of the synchronization sequences may be estimated one by one according to their sequence numbers (Step S22). Assuming that the sequence number of the acquired main synchronization sequence is m, the time offset of the main synchronization sequence relative to the beginning point of the transmission frame in the receiving signals is tₘ, the method for determining the synchronization position will be described below with reference to FIG. 9.

According to the predetermined time offset relation between the main synchronization sequence Sₘ and another synchronization sequence Sₖ, the synchronization position (synchronization time reference) of the synchronization sequence Sₖ in the corresponding receiving signal may be determined by the following equation:

$${t}_{k} = {t}_{m} + ( k - m ) \cdot \frac{{T}_{f}}{{N}_{T}} \qquad ( 10 )$$

Wherein, tₘ is the time reference point of the main synchronization sequence, tₖ is the time reference point of the synchronization sequence to be acquired, k is the sequence number of the synchronization sequence, k=0,1, . . . , N_{T}-1 and k≠m.

With reference to FIG. 8, since each of the synchronization sequences is corresponds to one transmit antenna, the receiver side may intentionally acquire the signals from different antennas according to the estimated synchronization time reference tₖ, and may further perform the synchronization detection tuning for the received signals at the estimated time reference point by utilizing the sliding correlation processing described by the equations (5)-(7), so that the synchronization sequences in the transmission signals from the different antennas may be acquired (Step S24).

Furthermore, the receiver side may further perform the phase demodulation processing described by the equation (8) on each of the acquired synchronization sequences, to acquire the phase offset φₖ′ of the synchronization sequences (Step S26). Moreover, by utilizing the acquired phase offset of the synchronization sequences and the phase offset deviation that is determined by the predetermined phase offset relation of the predetermined synchronization sequences relative to the known basic synchronization sequence, the synchronization position of the correlation processing for the synchronization sequences may be tuned finely and calibrated, to improve the corresponding synchronization precision (Step S28, similar to Step S20). Herein, the synchronization procedure for all the transmission signals is achieved. Because the synchronization sequences are associated with the transmit antennas, the transmit antennas corresponding to the transmission signals may be distinguished by using the synchronization sequences determined by the synchronization procedure.

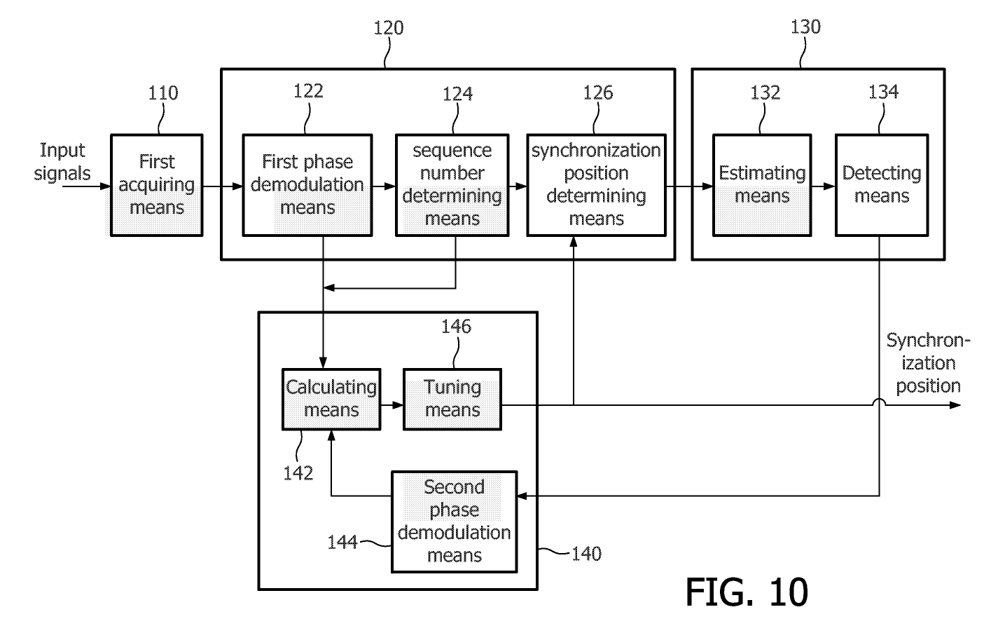

The above synchronization method for the mobile communication system described with reference to the FIG. 8 may be implemented in software, hardware, or the combination of software and hardware. When the synchronization method is implemented in hardware or the combination of software and hardware, the corresponding apparatus is shown in FIG. 10. The synchronization apparatus of the present invention will be described in detail below with reference to FIG. 10.

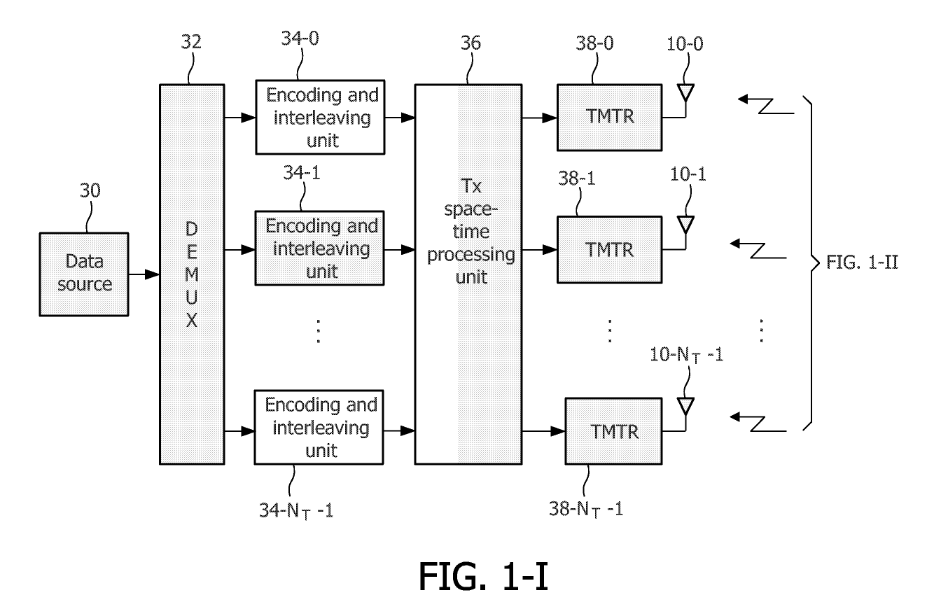

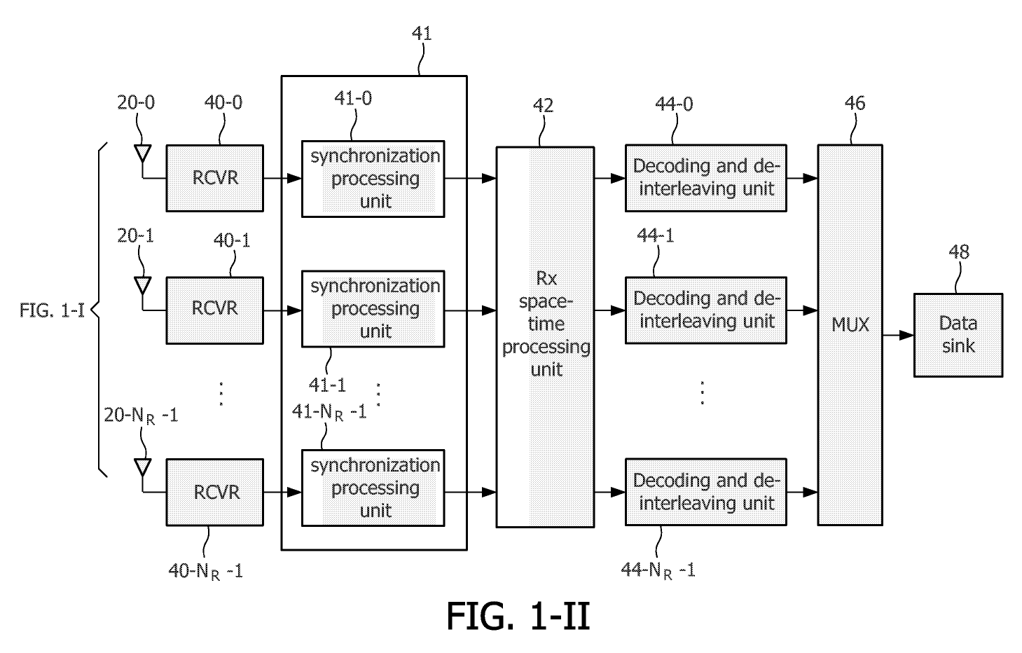

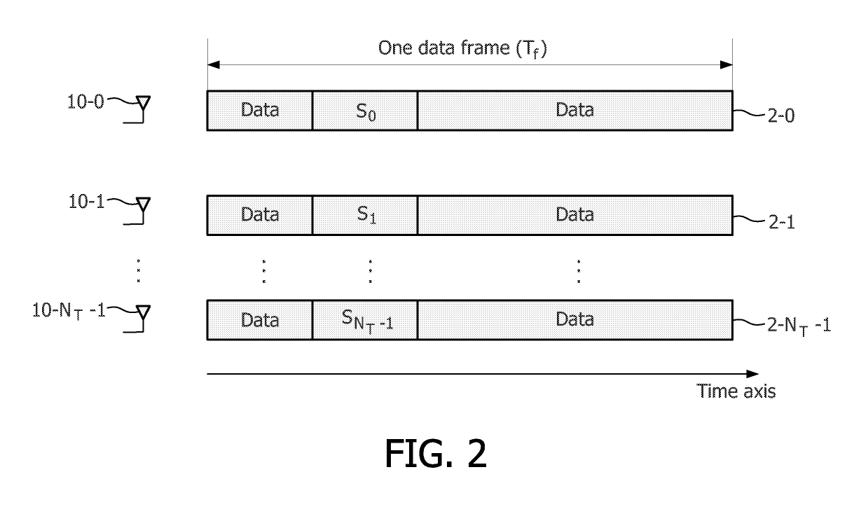

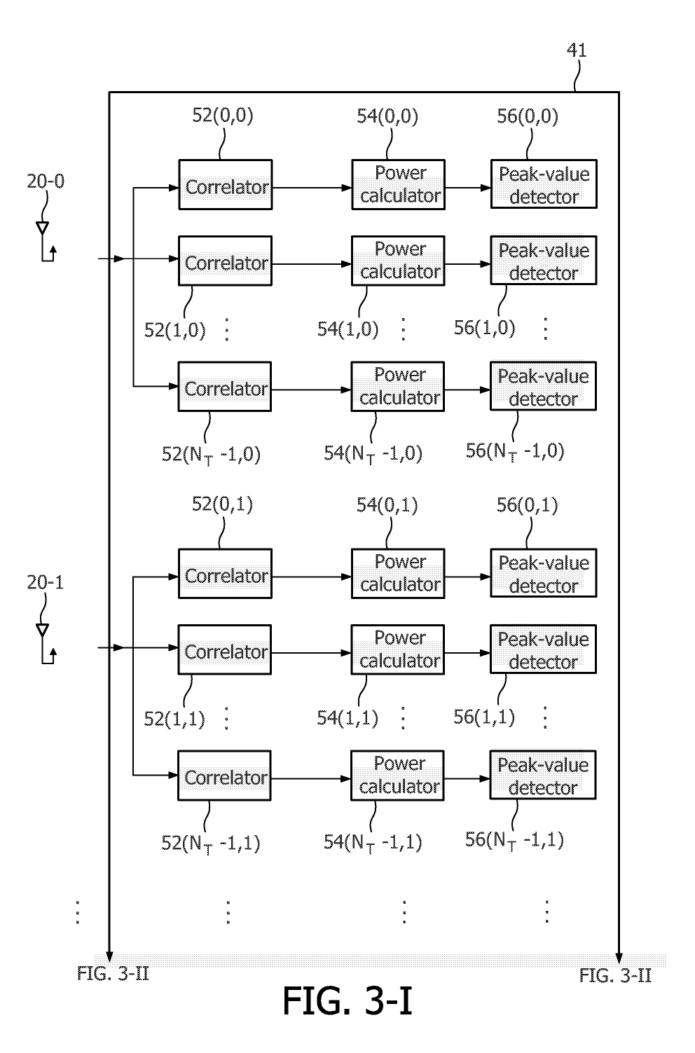

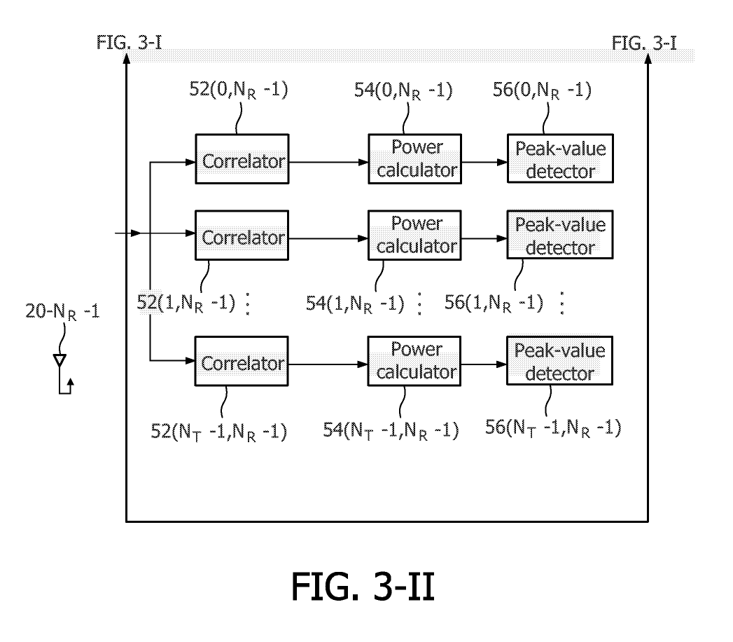

The synchronization apparatus shown in FIG. 10 comprises: a first acquiring means 110, a determining means 120, a second acquiring means 130 and a calibrating means 140. Wherein, the determining means 120 further comprises a first phase demodulation means 122, a sequence number determining means 124 and a synchronization position determining means 126. The second acquiring means 130 further comprises an estimating means 132 and a detecting means 134. The calibrating means 140 further comprises a second phase demodulation means 144, a calculating means 142 and a tuning means 146. The synchronization apparatus may functionally replace the multiple synchronization apparatuses (41-0, 41-1, . . . , 41-N_{R}-1) in the configuration schematic diagram of the MIMO communication system shown in FIG. 1, namely, the multiple synchronization apparatuses are combined as a synchronization apparatus and the synchronization sequences cooperate with each other during the acquiring processing. The working principle of the synchronization apparatus will be described below with reference to FIG. 10.

First, the first acquiring means 110 performs the sliding correlation processing for a group of the transmission signals extracted from the receiving signals by utilizing a known basic synchronization sequence, so that one of an expected group of the synchronization sequences after the channel fading, served as the main synchronization sequence, can be acquired (as shown in equation (5)). Since the synchronization sequences are dispersed in the transmission period without overlapping with each other, the sliding correlator only needs to perform the sliding correlation for a part of the receiving signals, so that one of the synchronization sequences can be randomly acquired, consequently, the time and computational amount for the sliding correlation processing may be reduced.

After the main synchronization sequence is acquired, the first phase demodulation means 122 in the determining means 120 performs the phase demodulation for the main synchronization sequence (as shown in equation (8)), to determine the phase offset of the main synchronization sequence relative to the known basic synchronization sequence; The sequence number determining means 124 may, based on the acquired phase offset and the predetermined phase offset between the group of the synchronization sequences and the basic synchronization sequence, determine the sequence number of the main synchronization sequence in the group of the synchronization sequences and the sequence numbers of the transmit antennas associated with the main synchronization sequence (as shown in equation (9)); Then, the synchronization position determining means 126 may, based on the real synchronization reference point and the acquired sequence number of the main synchronization sequence, and the predetermined time offset between the group of the synchronization sequences and the basic synchronization sequence (as shown in equation (4)), determine the synchronization position of the main synchronization sequence relative to the frame head of the transmission frame in the corresponding transmission signal.

After the sequence number and synchronization position of the main synchronization sequence are acquired, the estimating means 132 in the second acquiring means 130 may, based on the acquired sequence number and synchronization position of the main synchronization sequence, estimate the corresponding expected synchronization positions of other synchronization sequences in the group of the synchronization sequences one by one according to their sequence numbers (as shown in equation (10)), furthermore, the detecting means 134 may, based on the expected synchronization positions, respectively performs the correlation processing for the group of the transmission signals extracted from the receiving signals by utilizing a known basic synchronization sequence, so that the corresponding synchronization positions of the synchronization sequences may be detected. Different from the acquiring of the main synchronization sequence, since the acquired positions of these synchronization sequences are predetermined and the random sliding is not needed, the correlation processing executed in the detecting means 134 only needs to slide within a very small range to acquire their correlation peak-values, therefore, the efficiency of the acquiring may be improved greatly.

In the above synchronization apparatus, after the main synchronization sequence or other synchronization sequences are acquired, the calibrating means 140 may further perform the synchronization fine tuning for the synchronization sequences to improve their synchronization precision. Specifically, the calculating means 142 respectively calculates the deviation between the predetermined phase offset of each of the synchronization sequences and its acquired phase offset after demodulation. Wherein, the phase offset of the main synchronization sequence is acquired by the first phase demodulation means 122, and the phase offsets of other synchronization sequences are acquired by the second phase demodulation means 144. By using the phase deviation, the tuning means 146 performs the correlation processing as described in the equations (5-7), and respectively performs the synchronization fine tuning for each of the synchronization sequences to optimize the corresponding synchronization position. Different with the correlation processing executed in the first acquiring means 110 and the second acquiring means 130, in the calibrating means 140, the correlation processing is based on the detected correlation peak-value, and the synchronization fine tuning is only a processing to pursuit the precision gradually.

It should be appreciated by those skilled in the art that, the burst configuration, the method and apparatus for generating the burst, and the method and apparatus for estimating the channel parameters by using the burst configuration in the mobile communication system, which are disclosed in the present invention, may be used for not only the cellular communication system, but also the wireless LAN communication system and a plurality of communication systems that the receiver moves relative to the transmitter and the communication is performed by using the apparatus of the communication burst.

It can be appreciated by those skilled in the art that, various modifications may be made to the transmission signals, the method and apparatus for transmitting the transmission signals, and the method and apparatus for performing the synchronization processing by using the transmission signals in the wireless communication system, which are disclosed in the present invention, without departing from the scope of the present invention. Therefore, the protection scope of the present invention should be defined by the appended claims.

1. A method for synchronization in a receiver of a wireless communication system, comprising the steps of:
(a) Performing correlation processing for a group of transmission signals extracted from received signals by using a known basic synchronization sequence, to acquire one of an expected group of synchronization sequences as a main synchronization sequence of the system, wherein an instant corresponding to a correlation peak-value of the acquired synchronization sequence is a synchronization reference point;
(b) Determining an sequence number of the main synchronization sequence and its synchronization position relative to a specific time segment in the transmission signals, based on the synchronization reference point and a predetermined relation between the group of synchronization sequences and the known basic synchronization sequence; and
(c) Acquiring, based on the sequence number and the synchronization position of the main synchronization sequence and a predetermined relation between the main synchronization sequence and other synchronization sequences of the group of synchronization sequences, the other synchronization sequences respectively.

2. The method according to claim 1, wherein the step (b) comprises:
Performing phase demodulation for the main synchronization sequence, to acquire a phase offset of the main synchronization sequence relative to the known basic synchronization sequence;
determining, based on the phase offset of the main synchronization sequence and a predetermined phase offset relation between the main synchronization sequence and the known basic synchronization sequence, the sequence number of the main synchronization sequence, wherein the sequence number is correlated with the corresponding transmit antenna; and
Determining, based on the synchronization reference point and the sequence number of the main synchronization sequence and a predetermined time offset relation between the main synchronization sequence and the known basic synchronization sequence, the synchronization position of the main synchronization sequence relative to the specific time segment of the corresponding transmission signal.

3. The method according to claim 1, wherein, the step (c) comprises:
Estimating, based on the synchronization position of the main synchronization sequence and the predetermined time offset relation between the main synchronization sequence and other synchronization sequences, expected synchronization positions of other synchronization sequences; and
Performing, based on the expected synchronization positions, correlation processing for the group of transmission signals extracted from the received signals by using the known basic synchronization sequence, to determine synchronization positions of other synchronization sequences.

4. The method according to claim 2, further comprising:
(d) Performing, based on the phase offsets of each synchronization sequence and the predetermined phase offset relation between each synchronization sequence and the known basic synchronization sequence, synchronization fine tuning for each acquired synchronization sequence to optimize each corresponding synchronization position.

5. The method according to claim 4, wherein, the step (d) comprises:
Performing phase demodulation for each synchronization sequences respectively, to acquire the phase offset of each synchronization sequences relative to the known basic synchronization sequence;
Calculating the deviations between the predetermined phase offsets of the synchronization sequences and their acquired phase offsets after demodulation respectively; and
Tuning the time reference points of the synchronization sequences based on the phase deviations, and performing the synchronization fine tuning for the synchronization sequences respectively to optimize the corresponding synchronization positions.

6. The method according to claim 1, wherein, each of the group of transmission signals has a known duration, and comprises a synchronization sequence and at least one data segment respectively, wherein each synchronization sequence is inserted into corresponding transmission signal at different position according to corresponding predetermined time offset, and do not overlap with each other on a time axis.

7. The method according to claim 6, wherein each synchronization sequence is obtained respectively by performing the phase modulation for the known basic synchronization sequence according to each predetermined phase offset, wherein the phase offset of each synchronization sequence is different with each other, and their range is [0, 2π].

8. The method according to claim 7, wherein the transmission signals corresponding to the synchronization sequences are transmitted respectively by different transmit antennas.

9. The method according to claim 8, wherein the transmission signals have the same duration, and their period is the duration of a data transmission frame or a data transmission sub-frame.

10. The method according to claim 1, wherein the wireless communication system is one of MIMO (Multiple Input Multiple Output), SIMO (Single Input Multiple Output) and MISO (Multiple Input Single Output) communication system.

11. A apparatus for synchronization in a receiver of a wireless communication system, comprising:
A first acquiring means, for performing a correlation processing for a group of transmission signals extracted from received signals by using a known basic synchronization sequence, to acquire one of an expected group of the synchronization sequences as a main synchronization sequence, wherein an instant corresponding to a correlation peak-value of the main synchronization sequence is a synchronization reference point;
A determining means, for determining, based on the synchronization reference point and a predetermined relation between the group of synchronization sequences and the known basic synchronization sequence, an sequence number of the main synchronization sequence and its synchronization position relative to a specific time segment in the transmission signal; and
A second acquiring means, for acquiring, based on the sequence number and the synchronization position of the main synchronization sequence and a predetermined relation between the main synchronization sequence and other synchronization sequences of the group of synchronization sequences, other synchronization sequences respectively.

12. The apparatus according to claim 11, wherein the determining means comprises:
A first phase demodulation means, for performing the phase demodulation for the main synchronization sequence, to determine phase offset of the main synchronization sequence relative to the known basic synchronization sequence;
A sequence number determining means, for determining, based on the phase offset of the main synchronization sequence and a predetermined phase offset relation between the main synchronization sequence and the known basic synchronization sequence, the sequence number of the main synchronization sequence, wherein the sequence number is correlated with the corresponding transmit antenna; and
A synchronization position determining means, for determining, based on the synchronization reference point and the sequence number of the main synchronization sequence and a predetermined time offset relation between the main synchronization sequence and the known basic synchronization sequence, the synchronization position of the main synchronization sequence relative to the specific time segment of the corresponding transmission signal.

13. The apparatus according to claim 11, wherein the second acquiring means comprises:
A estimating means, for estimating, based on the synchronization position of the main synchronization sequence and the predetermined time offset relation between the main synchronization sequence and other synchronization sequences, expected synchronization positions of other synchronization sequences respectively; and
A detecting means, for performing respectively, based on the expected synchronization positions, the correlation processing for the group of transmission signals extracted from the received signals by using the known basic synchronization sequence, to determine synchronization positions of other synchronization sequences.

14. The apparatus according to claim 12, further comprises:
A calibrating means, for performing respectively, based on the phase offsets of each synchronization sequence and the predetermined phase offset relation between each synchronization sequence and the known basic synchronization sequence, synchronization fine tuning for each acquired synchronization sequence to optimize the corresponding synchronization position.

15. The apparatus according to claim 14, wherein the calibrating means comprises:
A second phase demodulation means, for performing respectively the phase demodulation for each synchronization sequence, to acquire the phase offsets of each synchronization sequence relative to the known basic synchronization sequence;
A calculating means, for calculating respectively the deviations between the predetermined phase offset of each synchronization sequences and its acquired phase offset after demodulation; and
A tuning means, for tuning the time reference points of the synchronization sequences based on the phase deviations, and performing respectively the synchronization fine tuning for each synchronization sequence to optimize the corresponding synchronization positions.

16. The apparatus according to claim 11, wherein each of the group of transmission signals has a known duration, and respectively comprises a synchronization sequence and at least one data segment, wherein each synchronization sequences is respectively inserted into corresponding transmission signals at different positions according to corresponding predetermined time offsets, and do not overlap with each other on a time axis.

17. The apparatus according to claim 16, wherein the synchronization sequences are obtained respectively by performing the phase modulation for the known basic synchronization sequence according to the predetermined phase offsets, wherein the phase offset of each synchronization sequences is different with each other, and the range is [0, 2π].

18. The apparatus according to claim 17, wherein the transmission signals corresponding to the synchronization sequences are transmitted by different transmit antennas respectively.

19. The apparatus according to claim 18, wherein the transmission signals have the same duration, and their period is the duration of a data transmission frame or a data transmission sub-frame.

20. The apparatus according to claim 11, wherein the wireless communication system is one of MIMO (Multiple Input Multiple Output), SIMO (Single Input Multiple Output) and MISO (Multiple Input Single Output) communication system.

21. A group of transmission signals for a wireless communication system, each of the transmission signals has a known transmission time, and comprises a synchronization sequence and at least one data segment, wherein the synchronization sequences are respectively inserted into the transmission signals at different positions according to predetermined time offsets, and do not overlap with each other on a time axis.

22. The transmission signals according to claim 21, wherein the synchronization sequences are obtained respectively by performing a phase modulation for the known basic synchronization sequence according to predetermined phase offsets, wherein the phase offset of each synchronization sequences is different with each other, and the range is [0, 2π].

23. The transmission signals according to claim 21, wherein the transmission signals corresponding to the synchronization sequences are transmitted by different transmit antennas respectively.

24. The transmission signals according to claim 23, wherein the transmission signals have the same duration, and their period is the duration of a data transmission frame or a data transmission sub-frame.

25. An apparatus for transmitting transmission signals, comprising:
A modulation means, for performing a modulation for a known basic synchronization sequence by using a group of predetermined phase offsets, to acquire a group of synchronization sequences;
An inserting means, for inserting the synchronization sequences into data streams at different positions according to the predetermined time offsets, to acquire a group of transmission signals;
A transmitting means, for associating the group of transmission signals with different transmit antennas respectively and transmitting them by the antennas.

26. The apparatus according to claim 25, wherein the synchronization sequences in the transmission signals do not overlap with each other on a time axis.

27. The apparatus according to claim 26, wherein the phase offsets of the synchronization sequences are different with each other, and their range is [0, 2π].

28. The apparatus according to claim 27, wherein the transmission signals have the same duration, and their period is the duration of a data transmission frame or a data transmission sub-frame.
